(19) United States
(12) Patent Application Publication
(10) Pub. No.: US 2014/0118663 A1
(43) Pub. Date: May 1, 2014

(54) COLOR SEPARATION SYSTEM

(71) Applicant: National Tsing Hua University, Hsinchu (TW)

(72) Inventors: Cheng-Huan CHEN, Hsinchu (TW); Po-Hung YAO, Hsinchu (TW)

(73) Assignee: National Tsing Hua University, Hsinchu (TW)

(21) Appl. No.: 14/067,365

(22) Filed: Oct. 30, 2013

(30) Foreign Application Priority Data
Nov. 1, 2012 (TW) 101140495

(51) Int. Cl. G02F 1/1335

(52) U.S. Cl. CPC G02F 1/1335
USPC 349/62

(57) ABSTRACT

The present invention discloses a color separation system, which uses a plurality of arrayed light source modules to generate light beams having different colors and separated spatially, and which uses a light guide module and an optical lens array to project the light beams having different colors to the display panel of an LCD device in an arrayed form, whereby the color separation system is exempted from using an absorption-type color filter, wherefore the light energy utilization rate is greatly increased. Further, the present invention arranges a reflection-type polarization element on the light output side of the optical lens array and arranges a quarter-wave plate on the bottom face of the light guide module to replace the conventional absorption-type polarization element. Thus, the light energy utilization rate is further increased. Therefore, the present invention can save energy effectively.

### BACKGROUND OF THE INVENTION

1. Field of the Invention

The present invention relates to a color separation system, particularly to a color separation system free of an absorption-type color filter.

2. Description of the Prior Art

In order to display colored images, the conventional LCD (Liquid Crystal Display) device adopts the absorption-type color filter to separate the white light, which comes from the backlight module, into red, green and blue light beams. However, the absorption-type color filter causes energy loss of about 60-70% incident light aboutwith 60-70%.energy. Besides, the absorption-type polarization plate absorbs about 50% of light energy. The two abovementioned factors obviously lower the total light energy utilization rate of the LCD device. Under the trend of environmental protection and energy saving, increasing the light energy utilization rate has become an important topic. Many schemes have been proposed to replace the absorption-type color filter and the absorption-type polarization plate, such as a technology using a color separation grating and a condensing lens array to generate colored pixels. However, high precision fabrication, high accuracy assemblage assembly and high cost required by these schemes are likely to hinder the application thereof.

Therefore, how to fabricate a color separation system having greatly enhanced light energy utilization rate and demanding lower alignment precision to replace the absorption-type color filter has become a target that the manufacturers are eager to achieve.

### SUMMARY OF THE INVENTION

The present invention provides a color separation system, which uses a plurality of arrayed light source modules to generate light beams having different colors and separated spatially, and which uses a light guide module and an optical lens array to project the light beams having different colors to the display panel of an LCD device in an arrayed form, whereby the color separation system avoids using an absorption-type color filter, wherefore the present invention greatly increases the light energy utilization efficiency.

One embodiment of the present invention proposes a color separation system, which comprises a plurality of light source modules arranged in array, a light guide module, and an optical lens array. Each light source module includes a plurality of light emitting elements emitting a plurality of light beams respectively having different central wavelengths and separated spatially, and an alignment lens aligning the plurality of light beams. The light guide module includes at least one light incident face, a light exit face and a bottom face. The bottom face is opposite to the light exit face, and the light incident face is connected with at least one of the bottom face and the light exit face. The plurality of light beams generated by the light source modules is projected onto the light incident face, reflected by the bottom face and emitted out of the light guide module from the light exit face. The optical lens array is arranged near the light exit face, diverting the plurality of light beams coming from the light exit face and projecting the plurality of light beams outward.

Below, the embodiments are described in detail in cooperation with the attached drawings to make easily understood the objectives, technical contents, characteristics and accomplishments of the present invention.

### BRIEF DESCRIPTION OF THE DRAWINGS

The foregoing conceptions and their accompanying advantages of this invention will become more readily appreciated after being better understood by referring the following detailed description, in conjunction with the accompanying drawings, wherein:

FIG. 1 schematically shows the structure of a color separation system according to one embodiment of the present invention;

FIG. 2A and FIG. 2B schematically show the structures of light source modules and a portion of a light guide module respectively according to different embodiments of the present invention;

FIGS. 3A-3C schematically show the structures of light source modules and a light guide module and illustrate several paths of light beams respectively according to different embodiments of the present invention; and

FIG. 4 schematically shows the structure of an optical lens array and illustrates paths of a portion of light beams according to one embodiment of the present invention.

### DESCRIPTION OF THE PREFERRED EMBODIMENT

The detailed explanation of the present invention is described as follows. The described preferred embodiments are presented for purposes of illustrations and description, and they are not intended to limit the scope of the present invention.

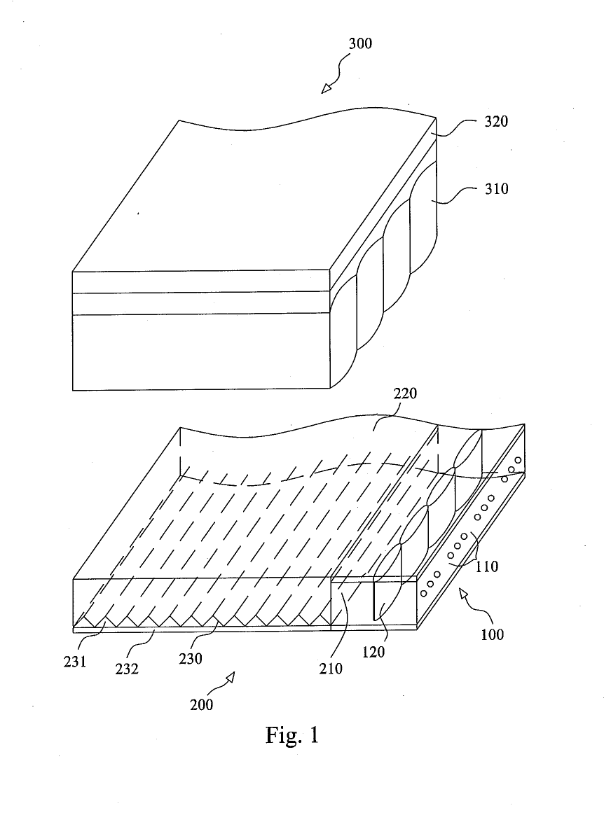

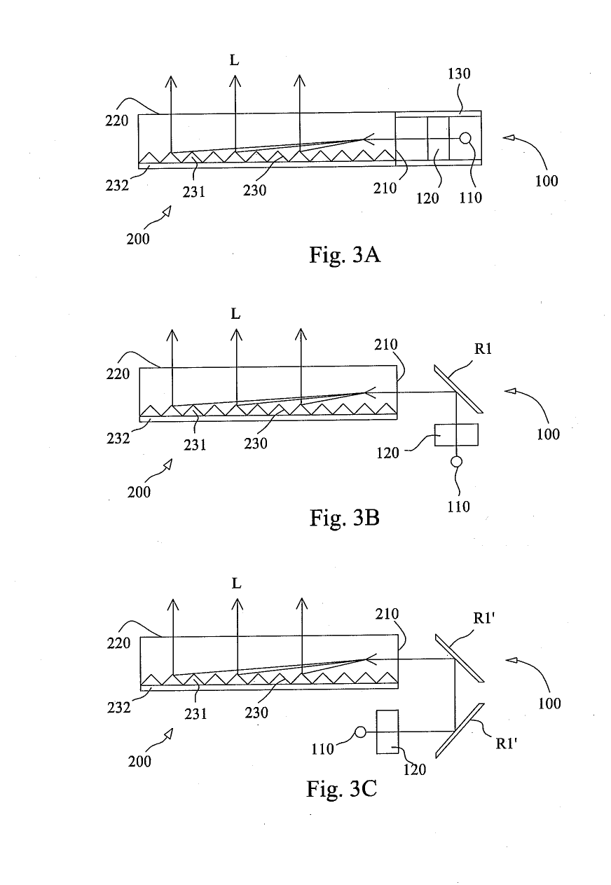

Refer to FIG. 1 schematically showing the structure of a color separation system according to one embodiment of the present invention. The color separation system of the present invention comprises a plurality of light source modules 100 arranged in array, a light guide module 200, and an optical lens array 300. Each light source module 100 includes a plurality of light emitting elements 110 emitting a plurality of light beams respectively having different central wavelengths and separated spatially, and an alignment lens 120 aligning the plurality of light beams L (shown in FIG. 3). The light guide module 200 includes a light incident face 210, a light exit face 220 and a bottom face 230. The bottom face 230 is opposite to the light exit face 220, and the light incident face 210 is connected with at least one of the bottom face 230 and the light exit face 220. The plurality of light beams L generated by the light source modules 100 is projected onto the light incident face 210, reflected by the bottom face 230 and emitted out of the light guide module 200 from the light exit face 220, as shown in FIG. 3A. The optical lens array 300 is arranged beside the light guide module 200 and near the light exit face 220, diverting the plurality of light beams L coming from the light exit face 220 and projecting the plurality of light beams L outward.

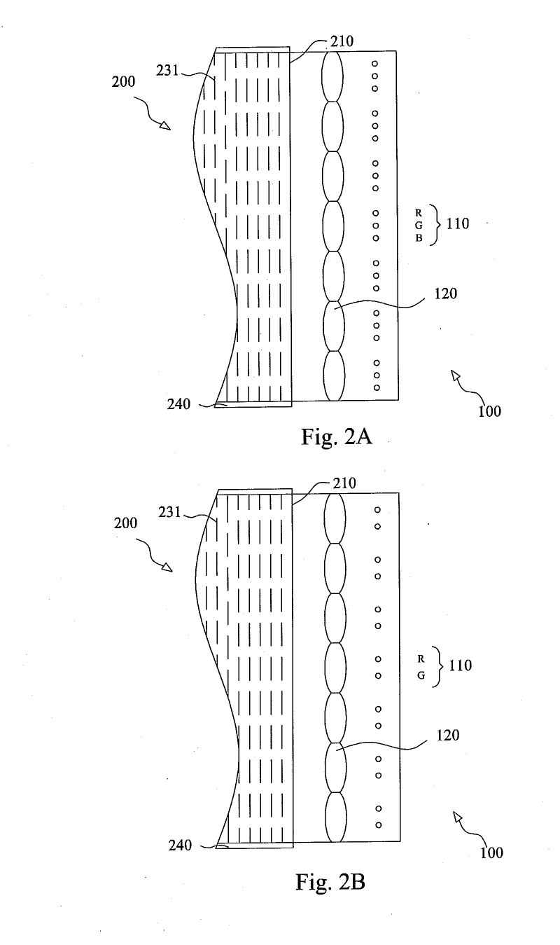

Refer to FIG. 2A and FIG. 2B schematically showing the structures of light source modules and a portion of a light guide module respectively according to different embodiments of the present invention. In each light source module 100, the plurality of light emitting elements 110 includes at least two of a red LED (Light Emitting Diode) (R), a green LED (G), a blue LED (B), and a white LED. In other words, the light emitting elements 110 of each light source module 100 are LEDs respectively emitting light beams of different colors. In one embodiment, each light module 100 contains three light emitting elements 110 respectively emitting RGB light beams. Thus, in the arrayed light source modules 100, the light emitting elements 110 are arranged in the form of RGBRGB—, as shown in FIG. 2A. In one embodiment, each light module 100 contains two light emitting elements 110 respectively emitting RG light beams. Thus, in the arrayed light source modules 100, the light emitting elements 110 are arranged in the form of RGRG—, as shown in FIG. 2B. Thereby, the present invention can generate light beams having different colors and separated spatially without using the absorption-type color filters. In one embodiment, light absorption elements 240 are arranged on at least one lateral face of the light guide module 200 to absorb the light beams projected on the lateral faces of the light guide module 200 to prevent these light beams from being reflected back to the light guide module 200.

Refer to FIG. 3A. While the light emitting elements 110 of the light source modules 100 emit a plurality of light beams L, the light beams L will pass through the alignment lens 120 and enter the light incident face 210 of the light guide module 120. The alignment lens 120 may be but is not limited to be a biconvex lens, a plane-convex lens, or a Fresnel lens. The alignment lens 120 converges the scattered light beams to enter the light guide module 200. The alignment lens 120 may be a separate component of the light source module 100 or integrated with the light guide module 200 to form a one-piece component. As the light emitting elements 110 are point light sources, they emit light omnidirectionally. Thus, a portion of the light does not enter the light alignment lens 120. It is a preferred measure to solve the problem: at least one reflective light guide element 130 is arranged on two lateral sides of the light source module 100 and parallel to the optical axis of the light alignment lens 120 to reflect a plurality of scattered light beams to the light incident face 210 of the light guide module 200. Thereby, the light source can be effectively used. In FIG. 3, the reflective light guide elements 130 are arranged on the upper side and the lower side of the light source module 100. It is preferred: the reflective light guide elements 130 are also arranged on the left side and the right side of the light source module 100.

After having passed through the alignment lens 120, the plurality of light beams L may enter the light incident face 210 directly (as shown in FIG. 3A). Alternatively, the light beams L are reflected one or several times and then projected onto the light incident face 210. In one embodiment, a first reflection element R1 is arranged between the alignment lens 120 and the light incident face 210 of the light guide module 200 to divert the light beams L to enter the light incident face 210, as shown in FIG. 3B. In this embodiment, the light beams L are reflected once by the first reflection element R1 before reaching the light incident face 210. In one embodiment, two second reflection elements R1′ are arranged between the alignment lens 120 and the light incident face 210 of the light guide module 200, as shown in FIG. 3C. In this embodiment, the light beams L are reflected twice by the second reflection elements R1′ before reaching the light incident face 210. In the present invention, the light path where the light beams L are reflected may be designed to meet requirement, and the relative position of the light source module 100 and the light guide module 200 can be flexibly adjusted in designing LCD panels, such as an edge-lit LCD panel.

In one embodiment, the light beams L emitted by the light source modules 100 do not go along a single path to the light guide module 200 but respectively go along at least two different paths to the light guide module 200. In one embodiment, the light guide module 200 includes two light incident faces 210 opposite to each other. Further, a plurality of light source modules 100 is arranged near each light incident faces 210, emitting a plurality of light beams L to each light incident face 210. The optical axes of the opposite alignment lenses 120 of the light source modules 100 respectively arranged next to the two light incident faces 210 are coaxial or shifted with a displacement. It is preferred to dispose the light source modules 100 and the light incident faces 210 in the space to achieve the color symmetry. In one embodiment, a plurality of light source modules 100 is arranged on an identical side of the light guide module 200 in the form of RGB and BGR alternatively. In one embodiment, the light source modules 100 are respectively arranged on the opposite sides of the light guide module 200 in the form of RGB. Both the two abovementioned embodiments involving the arrangement of light source modules can distribute light beams of different colors uniformly in the space. However, the arrangement of the light source modules 100 of the present invention is not limited by the abovementioned embodiments.

Refer to FIGS. 3A-3C. After entering the incident face 210, the light beams L are reflected by the bottom face 230 and projected outward from the light exit face 220. In one embodiment, the bottom face 230 has a microstructure reflecting light beams L to the light exit face 220. In one embodiment, the microstructure is an echelon grating. In one embodiment, the microstructure is a second reflection element 232 reflecting the light beams L to the light exit face 220.

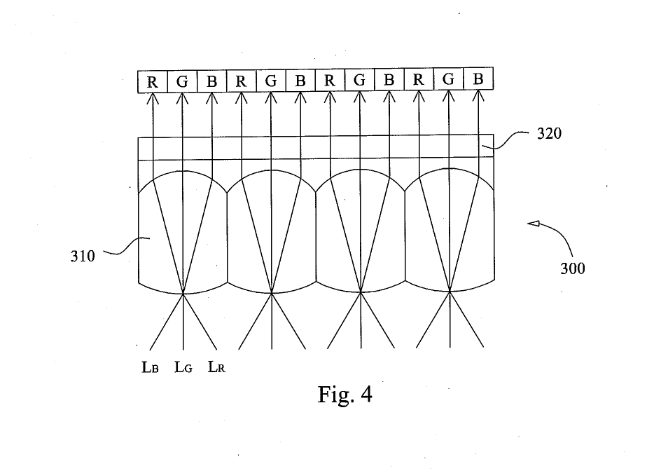

In the present invention, a plurality of light beams L is projected outward from the light exit face 220, respectively having different colors and separated spatially, as shown in FIG. 4. In one embodiment, the plurality of light beams L projected outward from the light exit face 220 includes light beams IR, IG and IB respectively having the three primary colors RGB, as shown in FIG. 4. The light beams IR, IG and IB enter the optical lens array 300. In one embodiment, the optical lens array 300 includes a plurality of cylindrical lenses 310. The cylindrical lenses 310 are convex cylindrical lenses used to focus the divergent light beams IR, IG and IB, which are projected outward from the light exit face 220 to the optical lens array 300, so that the light beams IR, IG and IB can be aligned to the pixels of the display panel accurately. In one embodiment, the light beams IR, IG and IB are projected out of the light exit face 220 by the optical lens array 300. However, the present invention is not limited by this embodiment.

The light wave has different polarities and contains the P wave and S wave. If a specified wave, such as the P wave, is desired, a polarization element is arranged on the light output side of the optical lens array 300 to filter out the S wave and allows the P wave to pass. Traditionally, an absorption-type polarization element is used to absorb the S wave. However, the method will lose 50% light energy and result in poor light output efficiency. Thus, the present invention adopts a reflection-type polarization element 320, which allows the wave having a specified polarity, such the P wave, to pass and reflects the S wave back to the light guide module 200. In order to recycle the light reflected back to the light guide module 200, a quarter-wave plate is arranged on the bottom face of the light guide module 200 to convert the vibration phase of a polarity of the light reflected by the reflection-type polarization element 320, i.e. convert the S wave into the P wave. The quarter-wave plate is an independent element or integrated with the second reflection element 232. After the S wave is converted into the P wave, the resultant P wave is emitted from the light guide module 200 and enters the optical lens array 300. Thereby, the light output efficiency is increased. In one embodiment, the reflection-type polarization element 320 is a nanowire-containing grating array or an element containing liquid crystal layers.

In conclusion, the present invention proposes a color separation system, which uses a plurality of arrayed light source modules to generate light beams having different colors and separated spatially, and which uses a light guide module and an optical lens array to project the light beams having different colors to the display panel of an LCD device in an arrayed form. The present invention exempts the color separation system from using an absorption-type color filter and thus greatly increases the light energy utilization rate. Further, the present invention arranges a reflection-type polarization element on the light output side of the optical lens array 300 and arranges a quarter-wave plate on the bottom face of the light guide module 200 to replace the conventional absorption-type polarization element. Thus, the light output efficiency is further increased. Therefore, the present invention can save energy effectively.

What is claimed is:

1. A color separation system comprising
a plurality of light source modules arranged in array and each including
a plurality of light emitting elements separately generating a plurality of light beams respectively having different central wavelengths and separated spatially; and
an alignment lens aligning said plurality of light beams;
a light guide module having at least one light incident face, a light exit face and a bottom face opposite to said light exit face, wherein said light incident face is connected with at least one of said light exit face and said bottom face, and wherein said plurality of light beams generated by said plurality of light source modules are emitted to said light incident face, reflected by said bottom face and projected out of said light guide module from said light exit face; and
an optical lens array arranged near said light exit face of said light guide module, diverting said plurality of light beams coming from said light exit face, and projecting said plurality of light beams outward.

2. The color separation system according to claim 1, wherein said plurality of light emitting elements of each said light source module include at least two of a red light emitting diode, a green light emitting diode, a blue light emitting diode and a white light emitting diode.

3. The color separation system according to claim 1, wherein said alignment lens and said light guide module are integrated into a one-piece component.

4. The color separation system according to claim 1, wherein said alignment lens is a biconvex lens, a plane-convex lens, or a Fresnel lens.

5. The color separation system according to claim 1, wherein said bottom face of said light guide module has a microstructure reflecting said plurality of light beams to said light exit face.

6. The color separation system according to claim 1, wherein said light guide module has two said light incident faces opposite to each other, and wherein a plurality of said light source modules is arranged beside each said light incident face, and wherein optical axes of said alignment lenses opposite to each other are coaxial or shifted with a displacement.

7. The color separation system according to claim 1, wherein said optical lens array includes a plurality of cylindrical lenses.

8. The color separation system according to claim 1 further comprising a reflection-type polarization element arranged on a light output side of said optical lens array for polarizing said plurality of light beams.

9. The color separation system according to claim 8, wherein said reflection-type polarization element is a nanowire-containing grating array or an element containing liquid crystal layers.

10. The color separation system according to claim 8 further comprising a quarter-wave plate arranged on said bottom face of said light guide module to convert the vibration phase of a polarity of said light beams reflected by said reflection-type polarization element.

11. The color separation system according to claim 1 further comprising at least one reflective light guide element arranged on two sides of said light source module, parallel to optical axis of said alignment lens, and used to reflect said plurality of light beams to said light incident face.

12. The color separation system according to claim 1 further comprising a first reflection element arranged between said alignment lens and said light incident face of said light guide module and diverting said plurality of light beams emitting to said light incident face.

13. The color separation system according to claim 1 further comprising a second reflection element arranged on said bottom face of said light guide module to reflect said plurality of light beams to said light exit face.

14. The color separation system according to claim 1 further comprising a light absorption element arranged on at least one lateral side of said light guide module and preventing said plurality of light beams from being reflected back to said light guide module.
